(19) United States
(12) Patent Application Publication
(10) Pub. No.: US 2021/0112179 A1
(43) Pub. Date: Apr. 15, 2021

(54) IMAGE PROCESSING APPARATUS, IMAGING APPARATUS, IMAGE PRINTING APPARATUS, METHOD FOR CONTROLLING IMAGE PROCESSING APPARATUS, AND IMAGE PROCESSING PROGRAM

(71) Applicant: SHARP KABUSHIKI KAISHA, Sakai City, Osaka (JP)

(72) Inventors: KEISUKE OMORI, Sakai City, Osaka (JP); KEI TOKUI, Sakai City, Osaka (JP)

(21) Appl. No.: 16/606,447

(22) PCT Filed: Jan. 16, 2018
(86) PCT No.: PCT/JP2018/001063

§ 371 Date: Oct. 18, 2019

(30) Foreign Application Priority Data
Apr. 20, 2017 (JP) 2017-084003

(51) Int. Cl. H04N 1/393; H04N 1/409; G06T 3/40; G06T 5/00

(52) U.S. Cl. CPC H04N 1/393; G06T 5/001; G06T 3/40; H04N 1/4092

(57) ABSTRACT

To correct an image more appropriately. A controller (40) reduces a first area in an image and enlarges a second area outside the first area to correct the image, and determine whether to clip a first side of the image depending on a distance from the first area to the first side of the image.

### TECHNICAL FIELD

An aspect of the present invention relates to an image processing apparatus performing a correction for deforming an image.

### BACKGROUND ART

Techniques are known in which an impression of an imaging object is changed by performing image processing to enlarge or reduce a part of an image. For example, these techniques include a technique for correcting the face of a person in the image so as to make the face smaller to provide an impression of a small face, a technique for correcting the whole body of a person in the image so as to make the whole body thinner to provide an impression of a slender body, and a technique for correcting the legs of a person in the image so as to make the legs longer to provide an impression of a good figure. As the technique for correcting a face in an image so as to make the face smaller, included in the above-described techniques, PTL 1 describes a technique in which the face is corrected so as to be smaller by configuring, as a deformation area, an area including a face area of a person and reducing the deformation area. In the technique disclosed in PTL 1, in a case that the configured deformation area is configured outside the image, the correction configured for the outside of the image is omitted to suppress degradation of image quality.

### CITATION LIST

### Patent Literature

PTL 1: JP 2009-104672 A

### SUMMARY OF INVENTION

### Technical Problem

However, in the technique described in PTL 1, the correction may or may not be performed depending on the position of the face of the person in the image. Thus, for example, in a case that a user takes an image by using a camera equipped with a function to correct the face in the image so as to make the face smaller, the effect intended by the user may fail to be obtained. For example, in a case that one image depicts multiple persons, a correction may be performed on the faces of persons located in the center of the image, and no correction may be made to the faces of persons located at ends of the image. Then, the impression provided by the image may be such that only some of the persons have a small face, whereas the faces of the persons subjected to no image correction are relatively large.

In view of the foregoing, a main object of an aspect of the present invention is to provide an image processing apparatus, an imaging apparatus, an image printing apparatus, a method for controlling an image processing apparatus, and an image processing program which are capable of more appropriately correcting an image.

### Solution to Problem

An image processing apparatus according to an aspect of the present invention includes a correction processing unit configured to reduce a first area in an image and to enlarge a second area outside the first area to correct the image, wherein in a case that a reduction direction of the first area extends from a first side of the image toward an inside of the first area, the correction processing unit determines whether to clip the first side of the image depending on a distance from the first area to the first side.

An image processing apparatus according to another aspect of the present invention includes a correction processing unit configured to reduce a first area in an image and to enlarge a second area outside the first area to correct the image, wherein in a case that a reduction direction of the first area extends from a first side of the image toward an inside of the first area, the correction processing unit determines whether to change the reduction direction of the first area to prevent the reduction direction from extending from the first side of the image toward the inside of the first area depending on a distance from the first area to the first side.

### Advantageous Effects of Invention

According to an aspect of the invention, the image can be more appropriately corrected.

### BRIEF DESCRIPTION OF DRAWINGS

FIG. 1 is a functional block diagram illustrating a configuration example of an image printing apparatus according to Embodiment 1 of the present invention.

FIG. 2 is a flowchart illustrating an example of a flow of image processing according to Embodiment 1 of the present invention.

FIG. 3 is a diagram illustrating an example (Processing Example 1) of image processing according to Embodiment 1 of the present invention.

FIG. 4 is a diagram illustrating an example (Reference Example 1) of image processing.

FIG. 5 is a diagram illustrating an example (Processing Example 2) of image processing according to Embodiment 1 of the present invention.

FIG. 6 is a diagram illustrating an example (Processing Example 3) of image processing according to Embodiment 1 of the present invention.

FIG. 7 is a diagram illustrating an example (Processing Example 4) of image processing according to Embodiment 1 of the present invention.

FIG. 8 is a diagram illustrating an example (Processing Example 5) of image processing in Embodiment 1 of the present invention.

FIG. 9 is a functional block diagram illustrating a modified example of an imaging apparatus according to Embodiment 1 of the present invention.

FIG. 10 is a diagram illustrating an example (Processing Example 6) of image processing according to Embodiment 2 of the present invention.

FIG. 11 is a diagram illustrating an example (Processing Example 7) of image processing according to Embodiment 2 of the present invention.

FIG. 12 is a diagram illustrating an example (Processing Example 8) of image processing according to Embodiment 2 of the present invention.

FIG. 13 is a diagram illustrating an example (Processing Example 9) of image processing according to Embodiment 3 of the present invention.

FIG. 14 is a diagram illustrating an example (Processing Example 10) of image processing according to Embodiment 4 of the present invention.

FIG. 15 is a functional block diagram illustrating an example of a configuration of a controller according to Embodiment 5 of the present invention.

FIG. 16 is a flowchart illustrating an example of a flow of image processing according to Embodiment 5 of the present invention.

FIG. 17 is a diagram illustrating an example (Processing Example 11) of image processing according to Embodiment 5 of the present invention.

FIG. 18 is a diagram illustrating an example (Processing Example 12) of image processing according to Embodiment 5 of the present invention.

### DESCRIPTION OF EMBODIMENTS

### Embodiment 1

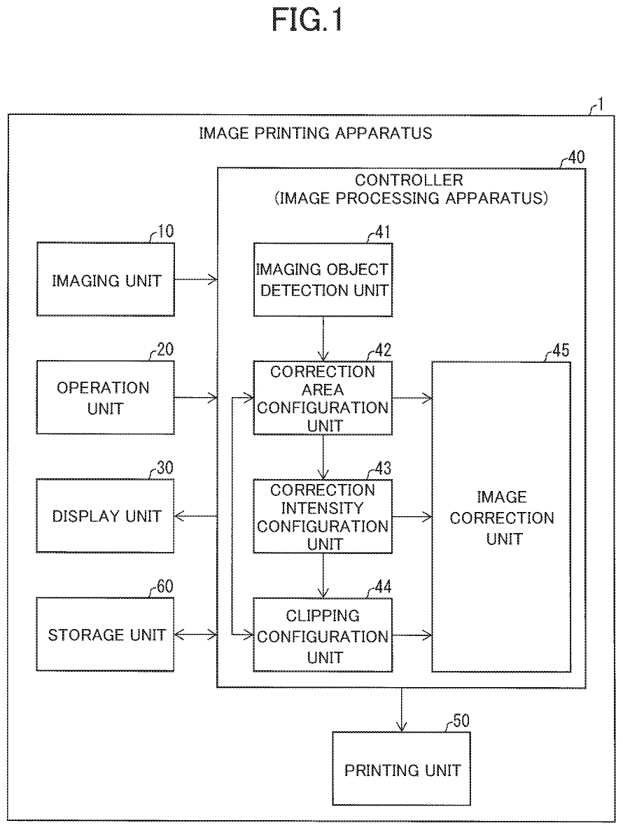

An embodiment (Embodiment 1) of the present invention will be described below, based on FIGS. 1 to 9.

### Configuration of Image Printing Apparatus

First, an example of a configuration of an image printing apparatus 1 according to an embodiment of the present invention will be described, based on FIG. 1. FIG. 1 is a functional block diagram illustrating the configuration of the image printing apparatus 1 in the present embodiment. As illustrated in FIG. 1, the image printing apparatus 1 includes an imaging unit 10, an operation unit 20, a display unit 30, a controller (image processing apparatus) 40, a printing unit 50, and a storage unit 60. Note that the imaging unit 10 and the controller 40 function as an imaging apparatus.

The imaging unit 10 images an imaging object, and transmits a captured image (image including a target area including the imaging object) to the controller 40 as an input image. The target area is an area on which the controller 40 performs reduction and enlargement processing.

The operation unit 20 receives a user input, and is implemented by, for example, a touch panel and a mouse. For example, in a case that the operation unit 20 is a touch panel, the input image is displayed on the display unit 30 including the touch panel.

The display unit 30 displays various images. The display unit 30 displays, for example, the image captured by the imaging unit 10 or an output image generated by an image correction unit 45 described below.

The controller 40 integrally controls the image printing apparatus 1. The controller 40 functions as an image processing apparatus performing image processing on the image (input image) captured by the imaging unit 10, and generates a processed (corrected) output image. A specific configuration of the controller 40 will be described below.

The printing unit 50 prints the output image (image) generated by the processing by the controller 40. The printing unit 50 may further print, on the output image, an image drawn by the user via the operation unit 20.

The storage unit 60 stores, for example, various control programs performed by the controller 40 and includes, for example, a non-volatile storage apparatus such as a hard disk and a flash memory. The storage unit 60 stores the input image and the output image, for example. The storage unit 60 may store parameters and the like necessary for processing by the controller 40, such as image processing (correction processing) and imaging object detection processing.

Note that the image printing apparatus 1 does not necessarily include the controller 40 functioning as an image processing apparatus. For example, an external apparatus capable of being communicatively coupled to the image printing apparatus 1 may include an image processing function of the controller 40.

The image printing apparatus 1 need not include an imaging apparatus including an imaging unit 10 and a controller 40 functioning as an image processing apparatus. In this case, the imaging apparatus may function as an external apparatus that can be communicatively coupled to the image printing apparatus 1 or may not include the function. The image printing apparatus 1 need not include the imaging unit 10, and in this case, for example, the imaging unit 10 functions as an external apparatus that can be communicatively coupled to the image printing apparatus 1.

### Configuration of Controller

Now, a specific configuration of the controller 40 will be described, based on FIG. 1. In order to perform functions of the image processing apparatus described above, the controller 40 includes an imaging object detection unit (target area detection unit) 41, a correction area configuration unit (correction processing unit) 42, a correction intensity configuration unit (correction processing unit) 43, a clipping configuration unit (correction processing unit) 44, and the image correction unit 45. The correction area configuration unit 42, the correction intensity configuration unit 43, the clipping configuration unit 44, and the image correction unit 45 are also collectively referred to as a correction processing unit.

The imaging object detection unit 41 detects an imaging object (target area) to be corrected from the input image input to the controller 40. Examples of the imaging object detected by the imaging object detection unit 41 include (1) a person, (2) the face of the person, (3) an organ of the face such as the eyes, the mouth, or the nose, and (4) a contour of the face. In a case that the imaging object detection unit 41 detects a face, for example, the imaging object detection unit 41 can detect an imaging object using an existing technique, such as utilization of information of a skin color area detected from the input image.

Note that detection of an imaging object by the imaging object detection unit 41 may be manual. In other words, a user may detect an imaging object from an input image. In this case, for example, the imaging object detection unit 41 (imaging object selection unit) causes the display unit 30 to display the input image, and detects (selects) the imaging object to be corrected specified by a user input via the operation unit 20. In a case that multiple imaging objects are present in the input image, the imaging object detection unit 41 selects an imaging object to be corrected, based on the user input.

For example, in a case that the operation unit 20 is a touch panel, touching the touch panel selects the imaging object in the input image to be displayed by the display unit 30. In a case that the operation unit 20 is a mouse, the imaging object is selected, based on a mouse operation.

In the description herein, correction processing is assumed to be performed on an image captured by the imaging unit 10 (i.e., an image including the imaging object). Specifically, in the description, reduction and enlargement processing is assumed to be performed on the imaging object included in the image. However, the present invention is not limited to this, and the image to be corrected need not be an image captured by the imaging unit 10. In this case, the imaging object detection unit 41 detects a target object to be corrected (in other words, the target area including the target object) included in the image. In other words, the imaging object detection unit 41 functions as a target area detection unit detecting the target area including the imaging object included in the image or the target object other than the imaging object (in other words, the target area included in the image).

The correction area configuration unit 42 configures, in the input image, the correction area to be corrected, based on information indicating the imaging object detected by the imaging object detection unit 41 (example: information indicating the position and size of the imaging object). The correction area configuration unit 42 configures an area including the imaging object included in the input image, in the input image as the reduction area (first area). The correction area configuration unit 42 configures, in the input image, an area outside the configured reduction area, specifically, an area adjacent to the reduction area, as an enlargement area (second area). In other words, the correction area configuration unit 42 configures the reduction area and the enlargement area as a correction area. Details will be described below.

The correction intensity configuration unit 43 configures an enlargement ratio and a reduction ratio for image correction. The correction intensity configuration unit 43 may use preset values as a scaling factor α (<1)) for reducing the reduction area configured in the input image and a scaling factor β (>1) for enlarging the enlargement area configured in the input image, or may use values configured in accordance with the input image or a user operation.

The clipping configuration unit 44 configures a clipping area to be clipped from the image to be finally output, based on the position and size of the reduction area configured by the correction area configuration unit 42. Details will be described below.

The image correction unit 45 reduces the reduction area, enlarges the enlargement area, and clips the clipping area to correct the input image and outputs the corrected input image to the printing unit 50 and/or the display unit 30 as an output image.

Note that the image correction unit 45 may use preset values as a first scaling factor (<1) for reducing the reduction area configured in the input image and a second scaling factor (>1) for enlarging the enlargement area configured in the input image, or may use values configured in accordance with the input image or the user operation.

### Flow of Processing by Controller

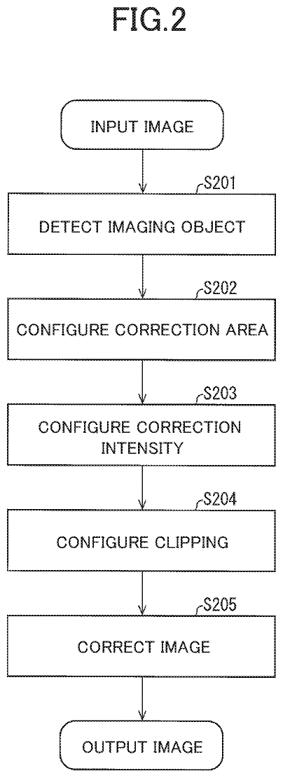

Now, a flow of image processing in the controller 40 of the image printing apparatus 1 according to the present embodiment will be described using FIG. 2. FIG. 2 is a flowchart illustrating an example of the flow of image processing in the controller 40.

In a case of acquiring the image captured by the imaging unit 10 as an input image, the imaging object detection unit 41 detects an imaging object to be corrected from the input image (S201: a target area detection step). The correction area configuration unit 42 configures the reduction area and the enlargement area, based on information indicated by the imaging object detected by the imaging object detection unit 41 (S202: a correction processing step). The correction intensity configuration unit 43 configures a correction intensity (scaling factor α of reduction in the reduction area and the scaling factor β of enlargement in the enlargement area), based on information indicating the reduction area and the enlargement area configured by the correction area configuration unit 42 (S203: a correction processing step). The clipping configuration unit 44 configures a clipping area, based on information indicating the reduction area and the enlargement area configured by the correction area configuration unit 42 and information indicating the correction intensity configured by the correction intensity configuration unit 43 (S204: a correction processing step). The image correction unit 45 reduces the reduction area, enlarges the enlargement area, and clips the clipping area to generate an output image (S205: a correction processing step). The controller 40 outputs the generated output image to the printing unit 50 or the display unit 30.

### Details of Correction Processing

Now, the details of the correction processing by the controller 40 will be described with processing examples.

### Processing Example 1

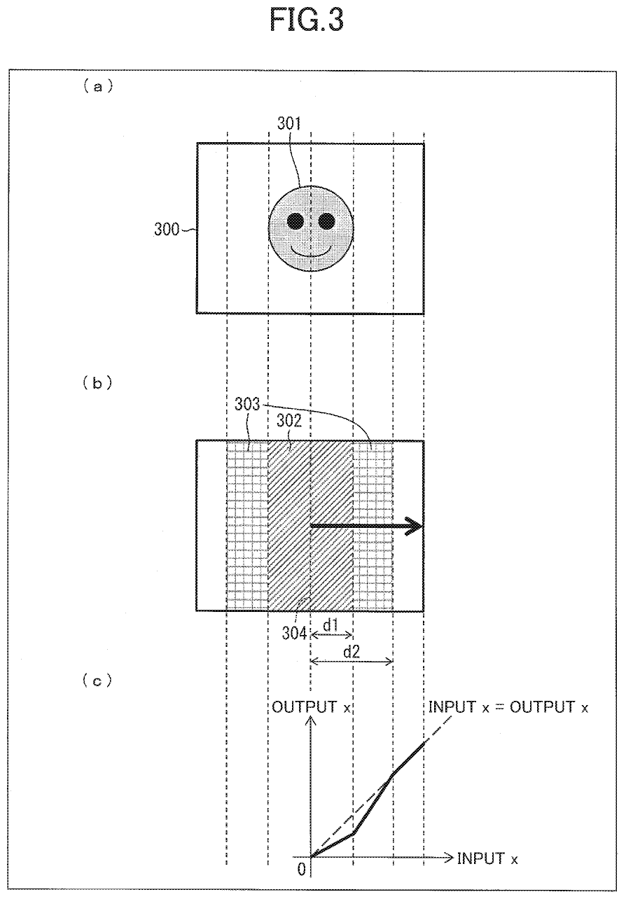

(a) of FIG. 3 illustrates an input image 300 used in Processing Example 1, and the input image 300 depicts a face (target area) 301 of a person. Here, by way of example, a case will be described in which the face 301 of the person is an imaging object to be corrected and is to be thinned by being reduced in a lateral direction.

(b) of FIG. 3 illustrates the correction area (the reduction area and the enlargement area) configured in the input image 300 by the correction area configuration unit 42 in Processing Example 1. As illustrated in (b) of FIG. 3, the correction area configuration unit 42 configures an area including the face 301 as a reduction area 302. Note that in Processing Example 1, the width of the reduction area 302 is the same as the width of the face 301 of the person, but the present embodiment is not limited to this. In Processing Example 1, the correction area configuration unit 42 configures the reduction area 302 such that the reduction area 302 traverses the input image 300 in a vertical direction. However, in the present embodiment, the shape of the reduction area is not limited to this (see Modified Example 1).

The correction area configuration unit 42 configures an area outside the reduction area 302 as an enlargement area 303. In Processing Example 1, the enlargement areas 303 are provided at opposing positions across and adjacent to reduction area 302. In Processing Example 1, the width of the each of the enlargement areas 303 is half of the width of the reduction area 302, but the present embodiment is not limited to this.

In Processing Example 1, the image correction unit 45 reduces the reduction area 302 in the lateral direction, and enlarges the enlargement areas 303 in the lateral direction. More specifically, assume that coordinates in a direction indicated by an arrow in FIG. 3B are x-coordinates, a distance from a centerline 304 of the reduction area 302 to a boundary between the reduction area 302 and the enlargement area 303 is d1, and a width from the centerline 304 of the reduction area 302 to an end of the enlargement area 303 opposite to the reduction area 302 is d2, this correction involves transferring, in a case of (1) 1≤d1, a point P=(1+c, y), where 1 is a distance from the centerline x=c of the reduction area 302, to a point P′=(α1+c, y) and in a case of (2) d1<1≤d2, to a point P′=(αd1+β(1−d1)+c, y). Here, a represents a positive constant configured by the correction intensity configuration unit 43 as a scaling factor (enlargement/reduction ratio) for the reduction area, and satisfies α<1. On the other hand, β represents a positive constant configured by the correction intensity configuration unit 43 as a scaling factor (enlargement/reduction ratio) for the enlargement area, is defined by β=(d2−αd1)/(d2−d1), and satisfies β>1.

For example, the correspondence relationship between the x-coordinate in the input image 300 and the x-coordinate in the output image is represented by a graph as illustrated in (c) of FIG. 3. Since the scaling factor α is configured to less than 1, the slope of the x-coordinate of the output image relative to the x-coordinate of the input image 300 in the reduction area 302 is less than 1. Thus, as illustrated in (c) of FIG. 3, the x-coordinate of the output image is smaller than the x-coordinate of the input image 300. As the distance to the enlargement area 303 decreases, the x-coordinate of the output image becomes increasingly smaller than the x-coordinate of the input image 300. This means that in the reduction area 302, reduction occurs toward the centerline 304 of the reduction area 302 and that the degree of the reduction (moving distance of pixels) increases consistently with the distance from the centerline 304.

On the other hand, the scaling factor β is configured to be greater than 1, and thus, the slope of the x-coordinate of the output image with respect to the x-coordinate of the input image 300 is also greater than 1. This means that in the enlargement area 303, enlargement occurs toward the centerline 304 of the reduction area 302 and that the degree of the enlargement (moving distance of pixels) decreases consistently with the distance from the centerline 304 increases.

The x-coordinate of the input image coincides with the x-coordinate of the output image at the end of the enlargement area 303 opposite to the reduction area 302. In this way, the area outside the enlargement area 303 in the input image 300 is not enlarged or reduced. Thus, the image correction unit 45 can generate an output image while preventing image quality from being degraded.

Note that it is sufficient that the image correction unit 45 specifies, for the reduction area 302, the amount of correction for each point P according to a distance r from the centerline 304 to the point P and that the image correction unit 45 need not make the amount of correction for each point P proportional to the distance r from a correction center c to the point P as described above.

### Reference Example 1

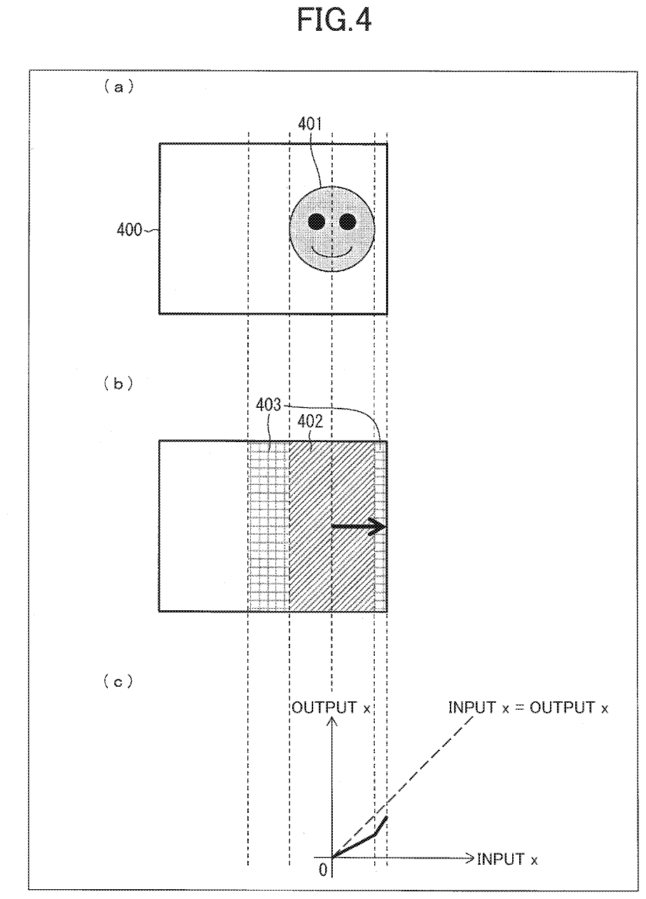

Now, a case will be described where configuration of a sufficient correction area in the input image is precluded in a case that the imaging object to be corrected is located at the image end or that the size of the correction target is large compared to the image. (a) of FIG. 4 illustrates an input image 400 used in Processing Example 2 and depicting a face 401 of a person in the input image 400. In Reference Example 1, unlike Processing Example 1, the face 401 of the person is located closer to a right end of the input image 400.

(b) of FIG. 4 illustrates a correction area (the reduction area and the enlargement area) configured in the input image 400 by the correction area configuration unit 42 in Reference Example 1. The correction area configuration unit 42 configures an area including the face 401 as a reduction area 402. In Reference Example 1, the width of the reduction area 402 is the same as the width of the face 401 of the person.

The correction area configuration unit 42 configures enlargement areas 403 such that the enlargement areas 403 are located opposite to each other across and adjacent to the reduction area 402. In Reference Example 1, the width of the enlargement area 403 on the left side of the reduction area 402 is half of the width of the reduction area 302 as in Processing Example 1. However, a right end of the input image 400 is located close to a right end of the reduction area 402, and thus, the width of the enlargement area 403 on the right side of the reduction area 402 is smaller than the width in Processing Example 1.

In Reference Example 1, in a case that correction processing is performed using the reduction ratio and the enlargement ratio configured under conditions similar to the conditions in Processing Example 1, the relationship between the x-coordinate of the input image 400 and the x-coordinate of the output image is represented by a graph illustrated in (c) of FIG. 4. As illustrated in (c) of FIG. 4, at the outermost side (=image end) of the right enlargement area 403, the x-coordinate of the input image 400 fails to coincide with the x-coordinate of the output image, and the x-coordinate of the input image 400 corresponding to the x-coordinate of the image end of the output image is not present. A point P=(1+c, y) corresponding to a point P′=(αd1+β (1−d1)+c, y) at the image end of the output image is located outside input image 400. Accordingly, the image end of the output image references the outside of the image of the input image 400, and the reference destination has indefinite pixel values. Thus, the image quality of the output image is degraded. In the related art described above, in a case that a sufficient correction area fails to be configured as in Reference Example 1, the correction itself is not performed, and thus the intended correction effect fails to be produced.

### Processing Example 2

In contrast, even in a case that the sufficient correction area fails to be configured, the controller 40 according to the present embodiment can generate, by appropriately clipping the end portion side of the output image, a preferable output image with the image quality of the image end prevented from being degraded while correcting the correction area with a pre-configured correction intensity.

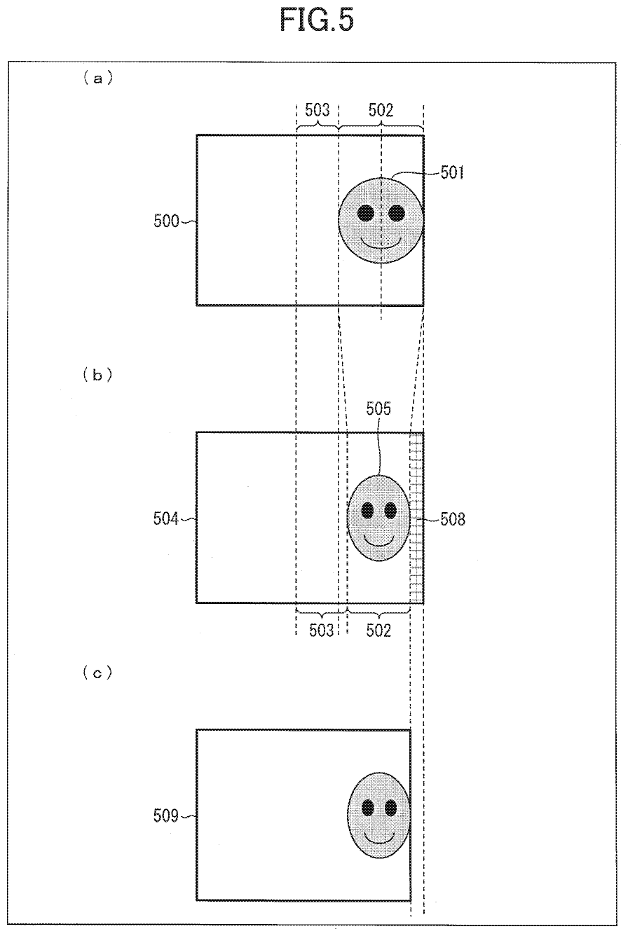

(a) of FIG. 5 illustrates an input image 500 used in Processing Example 2, and a correction area (a reduction area 502 and an enlargement area 503) configured in the input image 500 by the correction area configuration unit 42. In the input image 500, a face (target area) 501 of a person is located at the right end, and thus the correction area configuration unit 42 configures the reduction area 502 such that the reduction area 502 contacts a side on the right of the input image 500. The correction area configuration unit 42 also configures an enlargement area 503 only on the left side of the reduction area 502, and the enlargement area 503 fails to be configured on the right side of the reduction area 502.

(b) of FIG. 5 illustrates an output image 504 resulting from correction of the input image 500 in which the width of a face 505 is reduced. The width of the corrected face 505 of the person (=the width of the corrected reduction area 502) is smaller than the width of the uncorrected face 501 of the person (=the width of the uncorrected reduction area 502). At this time, the clipping configuration unit 44 configures, as a clipping area, a shaded area 508 at the right end of the output image 504. The area 508 is an area involving a reference destination outside the input image 500 and having indefinite pixel values. That is, a point P=(1+c, y) corresponding to P′=(αd1+β(1−d1)+c, y) in the area 508 is located outside the input image 500. As a result, as illustrated in (c) of FIG. 5, the image correction unit 45 can generate an output image 509 obtained by clipping, from the output image 504, the area 508 having indefinite pixel values. Thus, a preferable output image can be obtained that includes no area having indefinite pixel values.

In this way, in a case that a sufficient enlargement area can be configured, the controller 40 can enlarge the enlargement area to compensate for the effect of reduction of the reduction area, thus generating an output image while preventing deterioration of the image quality as in Processing Example 1. That is, the area outside the enlargement area in the image can be an area that is not reduced or enlarged. In a case that a sufficient enlargement area fails to be configured, the controller 40 can configure and clip the clipping area to obtain a preferable output image including no area having indefinite pixel values as in Processing Example 2.

To achieve such an effect, the clipping configuration unit 44 performs the following operation. In a case that the reduction direction of the reduction area extends from one side toward the inside of the reduction area, the clipping configuration unit 44 determines whether to clip a first side of the image depending on a distance from the reduction area to the first side. In a case that the first side is to be clipped, the clipping configuration unit 44 configures a clipping area on the first side. That is, in a case that the space between the reduction area (first area) and one side (first side) of the input image is narrow (e.g., in a case the reduction area contacts one side of the input image), the clipping configuration unit 44 configures a clipping area so as to clip the first side of the image, and otherwise configures no clipping area. The clipping area may be, for example, the one-side end portion of the corrected image.

Note that “clipping a certain side of an image” means removing, from the image, an area having a certain width from the certain side included in the image. The “reduction direction of the reduction area (first area)” refers to the direction in which the pixels in the reduction area move in a case that the reduction area is reduced. The “reduction direction of the reduction area extends from the one side toward the inside of the reduction area” means that the one-side pixels in the reduction area move toward the inside the reduction area. In this case, in a case that the reduction direction is represented by a vector and broken down into a vector in a certain direction and a vector in a direction orthogonal to the certain direction, the resultant vector in the certain direction is in a positive direction.

In a case that the reduction direction of the reduction area extends from a certain side toward the inside of the reduction area, the reduction area is reduced so as to move away from the certain side, and thus a sufficient enlargement area is preferably configured on the certain side of the reduction area in order to compensate for the effect of the reduction. However, in a case that the space between the reduction area and the certain side is narrow (for example, in a case that the reduction area contacts the certain side of the input image), a sufficient enlargement area fails to be configured. In such a case, as described in Reference Example 1, an area having indefinite pixel values is formed on the certain side of the reduction area. Thus, the clipping configuration unit 44 configures the clipping area so as to clip the certain side of the image, thus allowing a preferable output image to be obtained that includes no area having indefinite pixel values.

On the other hand, in a case that the space between the reduction area and the certain side is wide, a sufficient enlargement area can be configured. Thus, the clipping configuration unit 44 can generate an output image while preventing the image quality from being degraded without configuring the clipping area.

In other words, the clipping configuration unit 44 is configured such that, in a case that the reduction direction of the reduction area (the first area) extends from a certain side toward the inside of the reduction area, the clipping configuration unit 44 determines whether to clip the certain side of the corrected image depending on the distance from the reduction area to the certain side. This allows the image to be more appropriately corrected.

In an embodiment, the clipping configuration unit 44 is configured as follows. Assume that, in a case that the reduction direction of the reduction area extends from a certain side toward the inside of the reduction area, a distance from the center of the reduction area (first area) to a portion of the reduction area closest to the certain side is d1, a distance from the reduction area to the certain side (from the portion of the reduction area closest to the certain side to the certain side) is dx, an enlargement/reduction ratio for the reduction area is α, and an enlargement/reduction ratio for the enlargement area is β, the clipping configuration unit 44 configures a clipping area on the certain side of the image in a case that following Equation (1) is satisfied, and configures no clipping area in a case that Equation (1) is not satisfied.

(1−α)d1>(β−1)dx (1)

More particularly, in an embodiment, the clipping configuration unit 44 configures a clipping area with the width (1−α)d1−(β−1)dx on the certain side of the corrected image in a case that Equation (1) is satisfied. Accordingly, the controller 40 can clip the appropriate area from the corrected image. Note that the width of the clipping area configured by the clipping configuration unit 44 may be smaller than (1−α)d1−(β-1)dx and that, even in this case, a preferable output image can be obtained that includes a reduced area having indefinite pixel value. The width of the clipping area configured by the clipping configuration unit 44 may be greater than (1−α)d1−(β−1)dx, and even in this case, a preferable output image can be obtained that includes no area having indefinite pixel values. However, the clipping configuration unit 44 preferably provides the clipping area outside the reduced reduction area.

Note that in the processing example described above, the configuration has been described in which the reduction area is configured as a rectangular area traversing the input image in the vertical direction and is reduced in the lateral direction. However, the present embodiment is not limited to this. A correction method is not particularly limited, and various methods can be used, for example, (A) a configuration in which reduction and enlargement occur toward a specific straight line (configurations in Processing Examples 1 and 2 described above) and (B) a configuration in which reduction and enlargement occur toward a specific point (configurations in Processing Examples 3 to 5 described below). (A) In the configuration in which reduction and enlargement occur toward a specific straight line, the straight lines may be the center line of the reduction area or any other straight line, and the direction of the straight line may be the vertical direction, the lateral direction, or an oblique direction in the image. The shape of the reduction area and the enlargement area is not limited to a rectangle, and may partly include a curve. (B) In the configuration in which reduction and enlargement occur toward a specific point, the point may be the center of the reduction area or any other point, and the aspect of enlargement and reduction may be isotropic or anisotropic. The shape of the reduction area and the enlargement area is not limited to a circle, and may be an ellipse or a polygon. Hereinafter, as an example of (B) the configuration in which reduction and enlargement occur toward a specific point, a configuration in which reduction and enlargement occur toward the center of a circular reduction area will be described with processing examples.

### Processing Example 3

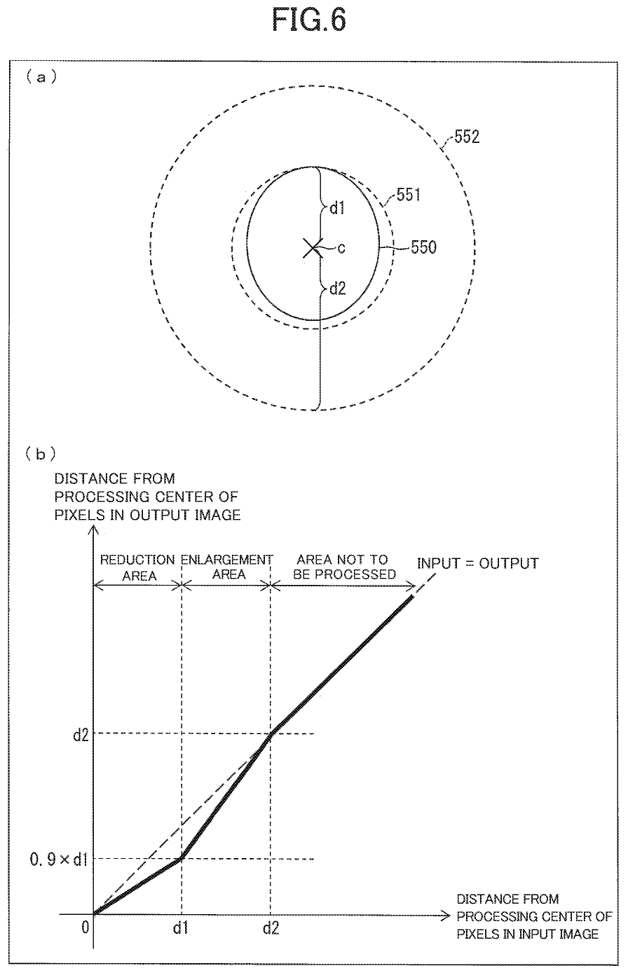

(a) of FIG. 6 is a diagram illustrating an example of a reduction area 551 and an enlargement area 552 configured by the correction area configuration unit 42 for a target area 550 to be corrected. As illustrated in (a) of FIG. 6, the reduction area 551 is a circular area centered at the correction center c and having a radius d1, and the enlargement area 552 is an area included in a circular area centered at the correction center c and having a radius d2, the enlargement area 552 being located outside the reduction area 551. Note that, as described above, the shape of the reduction area 551 and the enlargement area 552 is not limited to a circle.

The correction that the image correction unit 45 applies to the input image is a correction in which (1) the reduction area 551 is reduced toward the correction center c, and in which (2) the enlargement area 552 is enlarged toward the correction center c. More specifically, this correction involves transferring a point P=(r cos θ, r sin θ)+(c1, c2), where r represents a distance from the correction center c and θ represents a direction viewed from the correction center c=(c1, c2), to (1) a point P′=(r′ cos θ, r′ sin θ)+(c1, c2) in a case of r≤d1, where the distance from the correction center c is r′=αr and the direction viewed from the correction center c is θ, and to (2) a point P′=(r′ cos θ, r′ sin θ)+(c1, c2) in a case of d1<r≤d2, where the distance from the correction center c is r′=βr−(β−a)d1 and the direction viewed from the correction center c is θ. Here, α represents a positive constant configured by the correction intensity configuration unit 43 as an enlargement/reduction ratio for the reduction area 551, and satisfies α<1. On the other hand, β represents a positive constant configured by the correction intensity configuration unit 43 as an enlargement/reduction ratio for the enlargement area 552, is defined by β=(d2−αd1)/(d2−d1), and satisfies β>1.

For example, in a case of α=0.9 and β=1.1 (d2=2d1), a relationship between the distance r from the correction center c to an uncorrected point P and the distance r′ from the correction center c to a corrected point P is represented by a graph illustrated in (b) of FIG. 6. The enlargement area 552 is enlarged inward with an outer circumference maintained, and an inner circumference of a corrected enlargement area 552 coincides with an outer circumference of a corrected reduction area 551. The area outside the enlargement area 552 remains unchanged after the correction.

Note that it is sufficient that the image correction unit 45 specifies, for the reduction area 551, the amount of correction for each point P according to the distance r from the correction center c to the point P and that the image correction unit 45 need not make the amount of correction for each point P proportional to the distance r from the correction center c to the point P as described above.

As described above, the image correction unit 45 may further change the amount of correction for each point P according to the angle θ to reduce the reduction area 551 in an anisotropic manner.

### Processing Example 4

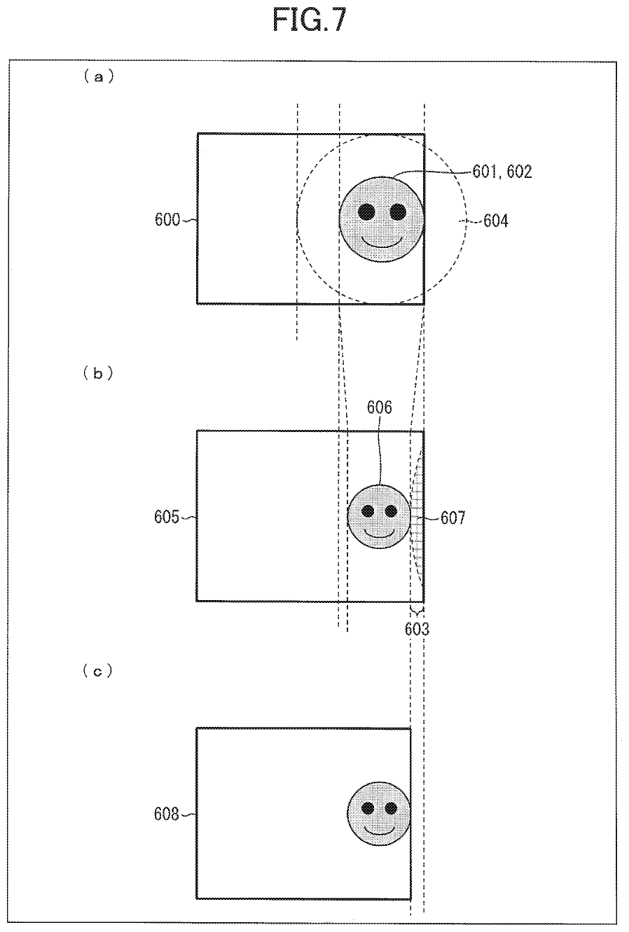

(a) of FIG. 7 illustrates an input image 600 used in Processing Example 4, and a face (target area) 601 of a person is located at the right end of the input image. In Processing Example 4, the controller 40 performs a correction to reduce the face 601 of the person toward the center of the face. The correction area configuration unit 42 configures a circle centered at the center of the face as a reduction area 602. The correction area configuration unit 42 configures the reduction area 602 such that an outer circumference of the reduction area 602 is located near the contour of the face 601 of the person. The correction area configuration unit 42 configures an enlargement area 604 outside the reduction area 602. However, since the face 601 of the person is located at the right end, the correction area configuration unit 42 fails to configure the enlargement area 604 on the right side of the face 602.

(b) of FIG. 7 illustrates an image 605 resulting from a correction for making the face 601 of the person smaller toward the center of the face with respect to the input image 600. A corrected face 606 of the person is smaller than the uncorrected face 601 of the person. A shaded area 607 illustrated at the right end of the image 605 indicates an area involving a reference destination outside the input image 600 and having indefinite pixel values. That is, the point P=(r cos θ, r sin θ)+(c1, c2) corresponding to P′=(r′ cos θ, r′ sin θ)+(c1, c2) in the area 607 is located outside the input image 600. Note that the area 607 in Processing Example 4 differs from the area 508 in Processing Example 2, having indefinite pixel values, in that, whereas the area 508 is rectangular, the area 607 is partly enclosed by a curve, and note that this is due to a difference in the correction method.

Thus, the clipping configuration unit 44 configures, instead of the area 607, a rectangular area 603 including the area 607 as a clipping area. Thus, as illustrated in (c) of FIG. 7, a preferable corrected image can be obtained that includes no area having indefinite pixel values and that is rectangular after clipping.

### Processing Example 5

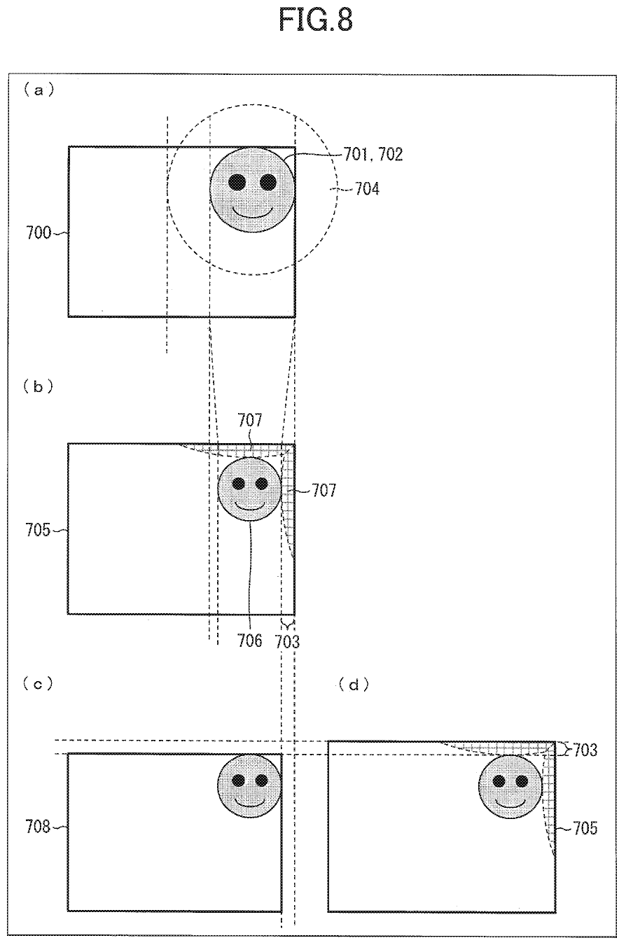

Now, a case will be described in which the target area to be corrected is located in a corner of the input image. (a) of FIG. 8 illustrates an input image 700 used in Processing Example 5, and a face (target area) 701 of a person is located at an upper right end of the input image. In Processing Example 5, as is the case with Processing Example 4, the controller 40 performs a correction in which the face 701 of the person is reduced toward the center of the face. The correction area configuration unit 42 configures a circle centered at the center of the face as a reduction area 702. The correction area configuration unit 42 configures the reduction area 702 such that an outer circumference of the reduction area 702 is located near the contour of the face 701 of the person. The correction area configuration unit 42 configures an enlargement area 704 outside the reduction area 702. However, since the face 701 of the person is located at the upper right end, the correction area configuration unit 42 fails to configure the enlargement area 704 on the right side of and above the face 702.

(b) of FIG. 8 illustrates an image 705 resulting from a correction for making the face 701 of the person smaller toward the center of the face with respect to the input image 700. A corrected face 706 of the person is smaller than the uncorrected face 701 of the person by the correction. Two shaded areas 707 respectively illustrated at the right end and the upper end of the image 705 indicate areas involving reference destinations outside the input image 700 and having indefinite pixel values. That is, a point P=(r cos θ, r sin θ)+(c1, c2) corresponding to P′=(r′ cos θ, r′ sin θ)+(c1, c2) in the area 707 is located outside the input image 700.

Thus, the clipping configuration unit 44 configures, as clipping areas, two rectangular areas 703 ((b) and (d) of FIG. 8) including the two areas 707 having indefinite pixel values. Accordingly, as illustrated in (c) of FIG. 8, a preferable correction image can be obtained that includes no area having indefinite pixel values and that is rectangular after clipping.

As described above, in the present embodiment, in a case that the correction area is located at the image end and the reference destination of a part of the output image is located outside the input image, the output image is clipped so as to exclude areas having indefinite pixel values due to a reference to the outside of the image, thus allowing a preferable corrected image to be obtained that includes no area having indefinite pixel values.

In particular, correction can be performed with a pre-configured correction intensity regardless of the position of the correction area. This allows the effect of the correction to be made constant regardless of the position of the correction area. Thus, in a case that faces of two persons are present at different positions in the image, e.g., at the center of the image and at the right end of the image, and that correction is performed to reduce each face, similar effects can preferably be exerted on the two persons.

### Supplemental Note

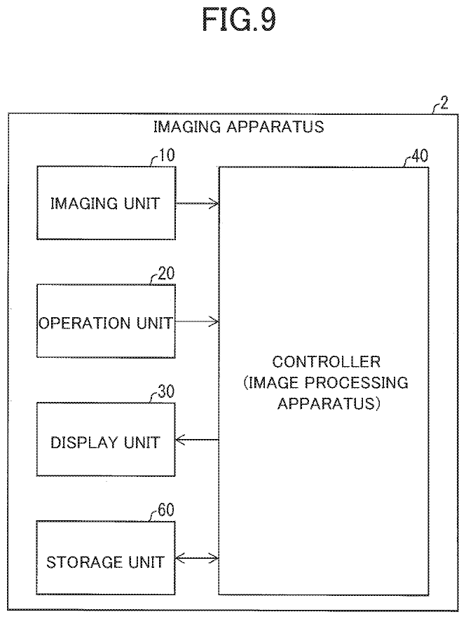

Another aspect of the present embodiment may be an image capturing apparatus including no printing function. FIG. 9 is a functional block diagram illustrating a configuration of an imaging apparatus 2 according to another aspect of the present embodiment. The imaging apparatus 2 includes the imaging unit 10, the operation unit 20, the display unit 30, the controller (image processing apparatus) 40, and the storage unit 60 similarly to the image printing apparatus 1, but does not include the printing unit 50. The imaging apparatus 2 may be configured as an image processing apparatus including only the controller 40.

### Embodiment 2

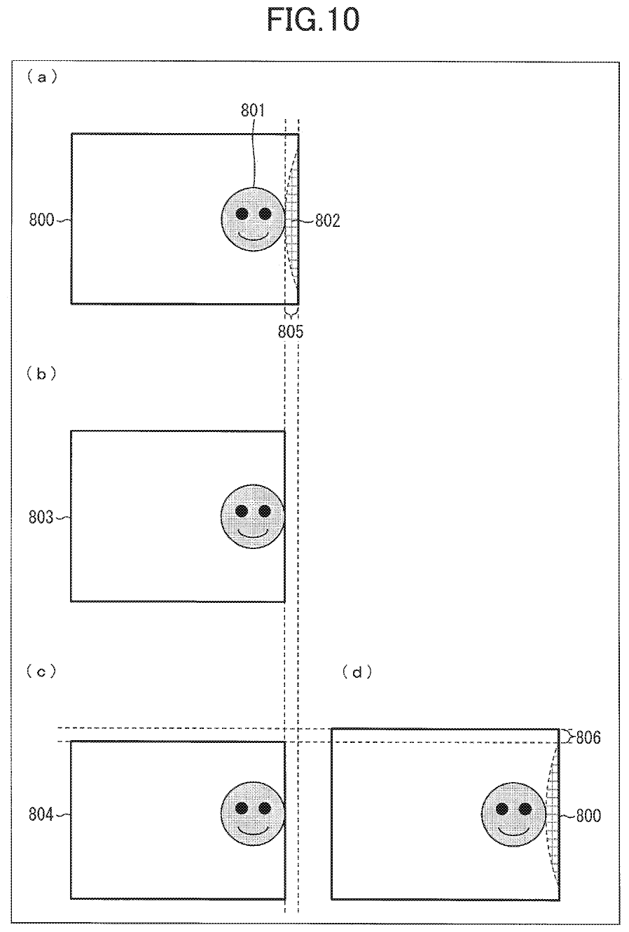

Another embodiment of the present invention (Embodiment 2) will be described below, based on FIGS. 10 to 12. Note that, for the sake of convenience of description, members including the same functions as those of the members described in the above embodiment are denoted by the same reference signs, and descriptions of the members are omitted.

In Embodiment 2, the controller 40 further clips an image resulting from clipping of an area having indefinite pixel values to generate a preferable output image having an aspect ratio unchanged after the correction. The correction processing according to the present embodiment will be described below with processing examples.

### Processing Example 6

(a) of FIG. 10 illustrates an input image containing a face (target area) 801 of a person and an image 800 resulting from correction of the input image for reducing the face 801, and a shaded area 802 represents an area having indefinite pixel values. The clipping configuration unit 44 configures, as a clipping area, a rectangular area 805 including the area 802.

(b) of FIG. 10 illustrates an image 803 resulting from clipping of the area 805. The image 803 corresponds to the image 800 with the right side clipped, and thus has an aspect ratio different from that of the image 800. For example, assume that the number of pixels in the image 800 corresponds to 1600 horizontal pixels for every 1200 vertical pixels, the aspect ratio of the image 800 is 4:3. On the other hand, the image 803 corresponds to the image 800 with the right side clipped, and thus has an aspect ratio different from that of the image 800. Assume that the number of pixels in the rectangular area clipped from the image 800 corresponds to 100 horizontal pixels for every 1200 vertical pixels, the number of pixels in the image 803 corresponds to 1500 horizontal pixels for every 1200 vertical pixels, and the aspect ratio of the image 803 is 5:4, which is different from the aspect ratio of the image 800.

Thus, in the present embodiment, the clipping configuration unit 44 configures, in addition to the rectangular area 805 including the area 802 having indefinite pixel values, a clipping area 806 on an upper side of the image 800, as illustrated in (d) of FIG. 10, such that an aspect ratio of the output image is the same as an aspect ratio of the input image. Thus, as illustrated in (c) of FIG. 10, the image 804 resulting from clipping of the clipping area by the image correction unit 45 corresponds to the image 803 from which the upper side for 1500 horizontal pixels for every 75 vertical pixels has been clipped. The number of pixels in the image 804 resulting from clipping corresponds to 1500 horizontal pixels for every 1125 vertical pixels, and the aspect ratio of the image 804 is 4:3. Thus, the image 804 has the same aspect ratio as that of the uncorrected image.

The unchanged aspect ratio produces the following effects. In a case that an image is displayed on a display apparatus such as a liquid crystal display, the entire image can be displayed as long as a display screen has the same aspect ratio as that of the image. On the other hand, in a case that the display screen does not have the same aspect ratio as that of the displayed image, no image is displayed in a part of the display screen (blank area). In a case that the images have different aspect ratios due to image correction (clipping), sequential display of multiple images on the display screen disadvantageously leads to a change in blank area each time the image is switched. However, in a case that multiple displayed images have the same aspect ratio, the blank area preferably remains unchanged in a case that the displayed image is switched. Not only in the case that the image is displayed on the display screen but also in a case that a printing apparatus is used to print the image on paper or as a photograph, printing can preferably be achieved without any blank area as long as the aspect ratio of print paper is the same as the aspect ratio of the image.

Note that the controller 40 need not necessarily perform the correction steps in the order of (a) to (c) of FIG. 10, and that the order of the steps may be changed or the steps may be performed concurrently.

As described above, in a case of having configured the clipping area on a certain side of the input image, the clipping configuration unit 44 clips a side of the input image (second side) that does not oppose the certain side (first side) such that the aspect ratio of the output image resulting from correction is the same as the aspect ratio of the uncorrected input image. This allows the output image that maintains the aspect ratio of the image to be obtained.

In an embodiment, assume that the number of horizontal pixels in the uncorrected input image is nx, the number of vertical pixels in the uncorrected input image is ny, and the width of the clipping area is w, (i) in a case that the target area is located close to the right side or left side of the input image and the clipping area is configured on the right side or left side of the input image, the clipping configuration unit 44 may further configure a clipping area with a width w(ny/nx) on the upper side or the lower side, and (ii) in a case that the target area is located close to the upper side or lower side of the input image and the clipping area is configured on the upper side or lower side of the input image, the clipping configuration unit 44 may further configure a clipping area with a width w(nx/ny) on the right side or the left side.

### Processing Example 7

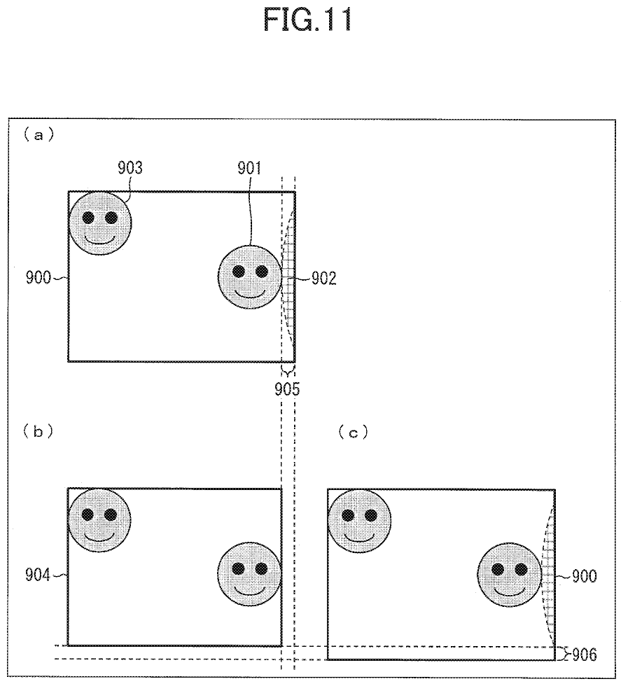

Now, a method for configuring a position where the image is clipped to adjust the aspect ratio will be described. (a) of FIG. 11 illustrates an input image containing a face (target area) 901 of a person and a face 903 of another person and an image 900 resulting from correction of the input image for reducing the face 901, and a shaded area 902 represents an area having indefinite pixel values. The clipping configuration unit 44 configures, as a clipping area, a rectangular area 905 including the area 902.

Here, in the present embodiment, in addition to the rectangular area 905 including the area 902 having indefinite pixel values, the clipping configuration unit 44 further configures a clipping area on the upper side or the lower side that does not oppose the right side on which the area 902 is configured in the image 900 such that the aspect ratio of the output image is the same as the aspect ratio of the input image.

In this case, in Processing Example 7, the clipping configuration unit 44 configures an area 906 on the lower side of the image 900 as a clipping area, as illustrated in (c) of FIG. 11, because the upper side of the image 900 depicts the face 903 of the person. As a result, the image 904 with the clipping area clip by the image correction unit 45 is preferable because the face 901 of the person and the face 903 of the person are both photographed, as illustrated in (b) of FIG. 11, and the aspect ratio is the same as the aspect ratio of the input image before correction.

Note that the criteria for selecting the clipping area from the candidate areas for the clipping area for the clipping configuration unit 44 to not change the aspect ratio of the image before and after correction is not limited to the criteria whether the face of the person is included. For example, in a case that no face of a person is contained in candidate areas for the clipping area for preventing the aspect ratio from being changed after correction, the clipping configuration unit 44 may determine whether each of the candidate areas contains an imaging object of interest other than persons and may configure, as a clipping area, a candidate area containing no imaging object of interest. In a case that none of the candidate areas contain a face of a person or an imaging object of interest, the clipping configuration unit 44 may calculate a feature amount for each candidate area and clip to exclude candidate areas with small feature amounts. The clipping configuration unit 44 can calculate the feature amount by using color information, for example, edge detection and saturation.

In other words, in a case of configuring a clipping area with a specific width (first width) on the upper side or the lower side (or the right side or the left side) to prevent the aspect ratio of the image from being changed after correction, the clipping configuration unit 44 configures a clipping area on one of the upper side and the lower side (or the right side and the left side) that contains no pixel of interest within a specific width from this side. Thus, the clipping configuration unit 44 can avoid losing important portions of the output image.

Here, the pixel of interest means a person, a feature point for detecting an imaging object of interest, or a pixel for detecting a feature amount.

### Processing Example 8

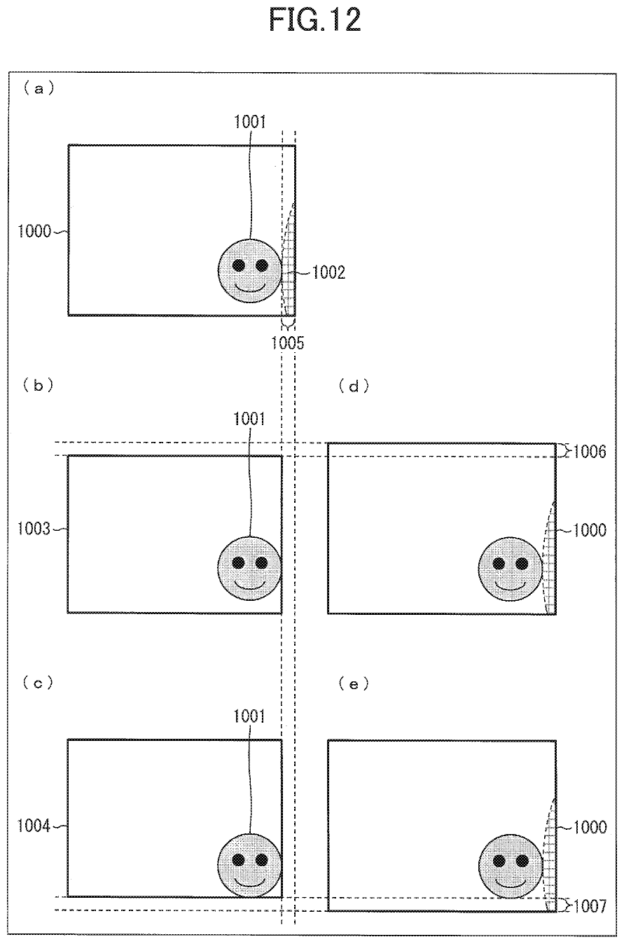

Now, as a method for configuring the position at which the image is clipped to adjust the aspect ratio, a method based on the position of a face of a person may be used. (a) of FIG. 12 illustrates an input image containing a face (target area) 1001 of a person and an image 1000 resulting from correction of the input image for reducing the face 1001, and a shaded area 1002 represents an area having indefinite pixel values. The clipping configuration unit 44 configures, as a clipping area, a rectangular area 1005 including the area 1002.

Here, in the present embodiment, in addition to the rectangular area 1005 including the area 1002 having indefinite pixel values, the clipping configuration unit 44 further configures a clipping area on the upper side or the lower side that does not oppose the right side on which the area 1002 is configured in the image 1000 such that the aspect ratio of the output image is the same as the aspect ratio of the input image.

In this case, in Processing Example 8, the clipping configuration unit 44 configures, as a clipping area, an area 1006 on the upper side of the image 1000 that is a side farther from the reduction area including the person 1001, as illustrated in (d) of FIG. 12. Thus, as illustrated in (b) of FIG. 12, the image 1003 resulting from clipping of the clipping area by the image correction unit 45 depicts the face 1001 of the person at a position close to the center of the image 1003. Thus, preferably, the target area to be used as an object of interest can be moved closer to the center of the image, and the image 1003 has the same aspect ratio as that of the uncorrected input image.

Note that in a case that the clipping configuration unit 44 configures an area 1007 on the lower side of the image 1000, which is a side closer to the reduction area including the person 1001, as the clipping area, as illustrated in (e) of FIG. 12, the image 1004 resulting from clipping of the clipping area by the image correction unit 45 depicts the face 1001 of the person at a position away from the center of the image 1003, as illustrated in (c) of FIG. 12.

### Embodiment 3

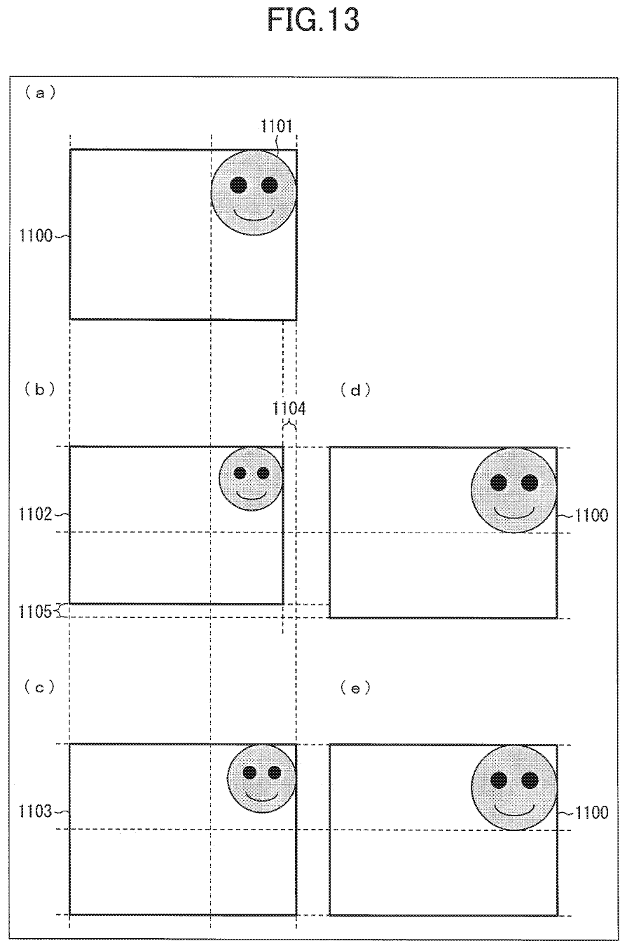

Another embodiment (Embodiment 3) of the present invention will be described below, based on FIG. 13. Note that, for the sake of convenience of description, members including the same functions as those of the members described in the above embodiments are denoted by the same reference signs, and descriptions of the members are omitted.

In Embodiment 3, the controller 40 performs a pixel number conversion on an image with the aspect ratio adjusted to generate a more preferable output image. The correction processing according to the present embodiment will be described below with processing examples.

### Processing Example 9

(a) of FIG. 13 illustrates an image 1100 used in Processing Example 9 and depicting a face (target area) 1101 of a person.

(b) of FIG. 13 illustrates an image 1102 obtained by performing an image correction for making the face 1101 of the person smaller, clipping a clipping area that is an area 1104 having indefinite pixel values, and clipping a clipping area 1105 to adjust the aspect ratio, as is the case with Processing Examples 6 to 8. The image 1102 illustrated in (b) of FIG. 13 and the image 1100 illustrated in (d) of FIG. 13 are the same in the aspect ratio but are different from each other in the number of pixels in the image due to clipping of the clipping areas. In this case, in a case that the imaging apparatus is used to capture an image, an image with the number of pixels smaller than the pre-configured number of pixels is output.

Thus, in the present embodiment, in a case that clipping the clipping area that is the area 1104 having indefinite pixel values and clipping the clipping area 1105 to adjust the aspect ratio lead to the numbers of vertical and horizontal pixels in the image differing from the numbers of vertical and horizontal pixels in the input image, the image correction unit 45 enlarges the image 1102 resulting from clipping of the clipping area such that the input image and the output image are equal in the numbers of vertical and horizontal pixels.

Image enlargement processing can be performed by a known interpolation method such as a nearest-neighbor method, a bilinear method, a bicubic method, or the like. (c) of FIG. 13 illustrates an image 1103 resulting from enlargement of the image 1102 by the image correction unit 45. The image 1103 illustrated in (c) of FIG. 13 is equal to the image 1100 illustrated in (e) of FIG. 13 in the size of the image (the number of pixels), and a correction has been performed to make the face 1101 smaller. Thus, the image correction unit 45 can generate an image that has the same number of pixels as that in the input image and in which an imaging object to be corrected has been preferably corrected.

Note that the controller 40 need not necessarily perform the adjustment of the aspect ratio based on clipping and the pixel number conversion in the order of (a) to (c) of FIG. 13 in the correction, and that the order of these steps may be changed or the steps may be performed concurrently.

### Embodiment 4

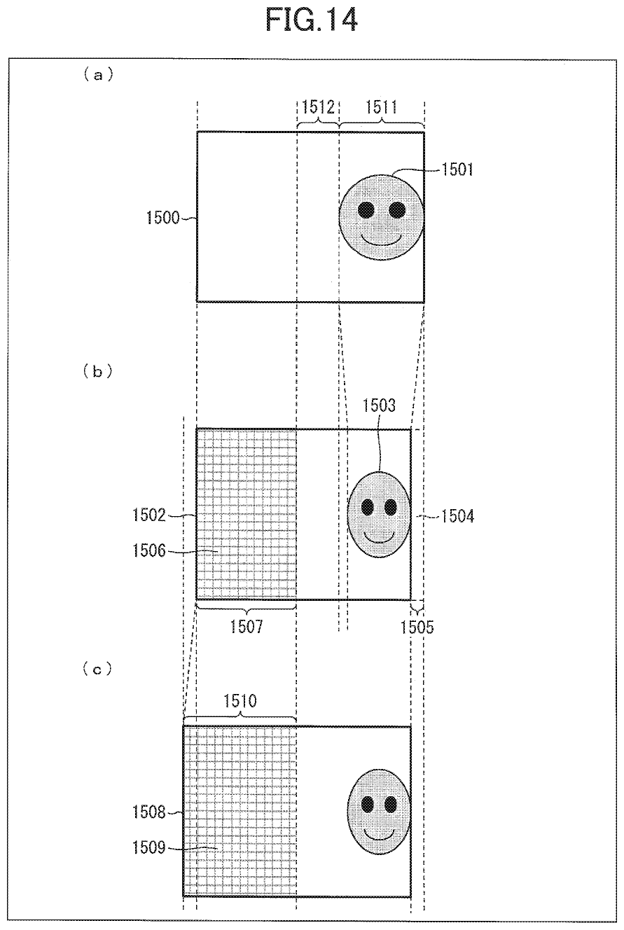

Another embodiment (Embodiment 4) of the present invention will be described below, based on FIG. 14. Note that, for the sake of convenience of description, members including the same functions as those of the members described in the above embodiments are denoted by the same reference signs, and descriptions of the members are omitted.

The controller 40 enlarges a partial area of an image resulting from clipping of an area having indefinite pixel values to generate a preferable output image with the aspect ratio of the image unchanged after correction. The correction processing according to the present embodiment will be described below in detail with processing examples.

### Processing Example 10

(a) of FIG. 14 is a diagram illustrating an image 1500 used in the Processing Example 10 and containing a face (target area) 1501 of a person. The correction area configuration unit 42 configures a reduction area 1511 and an enlargement area 1512 in the image 1500.

(b) of FIG. 14 illustrates an image 1502 resulting from a correction for reducing the face 1501 and from clipping of an area 1505 having indefinite pixel values. The image 1502 results from clipping of the right side of the image 1500 and thus has an aspect ratio different from that of the image 1500.

Thus, in the present embodiment, the correction area configuration unit 42 configures a second enlargement area (third area) 1506 on a side (left side, third side) opposite, with respect to the reduction area 1511, to a side (right side, first side) from which an image has been clipped such that the aspect ratio of the output image is the same as the aspect ratio of the input image, as illustrated in (b) of FIG. 14. Thus, an image 1508 has a width 1510 to which the width of the second enlargement area 1506 has been increased from the width 1507 by the image correction unit 45 compensates for the number of horizontal pixels reduced by clipping of the area 1505, and has the same aspect ratio as that of the uncorrected image, as illustrated in (c) of FIG. 14.

Accordingly, unlike in Embodiment 2, the aspect ratio can be adjusted without unnecessary clipping. Note that the second enlargement area 1506 is preferably wider. A wider second enlargement area 1506 makes the enlargement/reduction ratio β for the second enlargement area 1506 close to 1, allowing degradation of the quality of the output image to be suppressed.

The correction area configuration unit 42 preferably specifies, as the second enlargement area 1506, a part of the area located on the side opposite, with respect to the reduction area, to the side of the reduction area from which the image has been clipped, the part including no pixel of interest. This allows avoidance of containment of a face of a person and the like in the second enlargement area 1506 leading to deformation of the face and the like.

### Embodiment 5

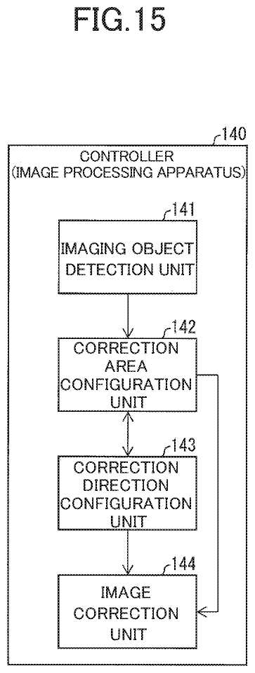

Another embodiment (Embodiment 5) of the present invention will be described below, based on FIGS. 15 to 18. Note that, for the sake of convenience of description, members including the same functions as those of the members described in the above embodiments are denoted by the same reference signs, and descriptions of the members are omitted.

In a case that the reduction area is located closer to a certain side (first side) of the input image to prevent an enlargement area with a sufficient width from being configured on the first side of the reduction area, the image processing apparatus according to the present embodiment changes the reduction direction of the reduction area to avoid formation of an area having indefinite pixel values. This differs from the configuration of a clipping area on the first side by the image processing apparatus according to Embodiments 1 to 4.

FIG. 15 is a functional block diagram illustrating an example of a configuration of a controller according to the present embodiment. The image printing apparatus according to the present embodiment has a configured similar to the image printing apparatus 1 according to Embodiment 1, except that a controller (image processing apparatus) 140 is provided instead of the controller 40. As illustrated in FIG. 15, the controller 140 includes an imaging object detection unit 141, a correction area configuration unit 142, a correction direction configuration unit 143, and an image correction unit 144. The correction area configuration unit 142, the correction direction configuration unit 143, and the image correction unit 144 are collectively referred to as a correction processing unit.

The imaging object detection unit 141 has functions similar to the imaging object detection unit 41. The correction area configuration unit 142 has functions similar to the correction area configuration unit 42. The correction direction configuration unit 143 has functions similar to the correction intensity configuration unit 43, and further includes a function to change the reduction direction of the reduction area and the enlargement area, and a function to configure the clipping area, as described below. The image correction unit 144 has functions equivalent to the image correction unit 45.

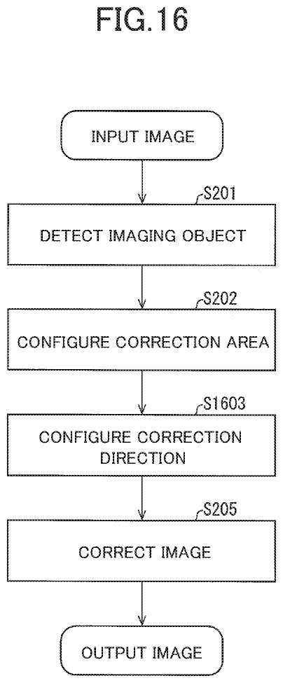

Now, a flow of image processing in the controller 140 according to the present embodiment will be described by using FIG. 16. FIG. 16 is a flowchart illustrating an example of the flow of image processing in the controller 140.

In a case of acquiring an image captured by the imaging unit 10 as an input image, the imaging object detection unit 141 detects an imaging object to be corrected from the input image (S201: a target area detection step). The correction area configuration unit 142 configures the reduction area and the enlargement area, based on information indicated by an imaging object detected by the imaging object detection unit 41 (S202: a correction processing step). The correction direction configuration unit 143 configures, based on the information indicated by the reduction area and the enlargement area configured by the correction area configuration unit 42, a correction intensity (a scaling factor α for the reduction of the reduction area and a scaling factor β for enlargement of the enlargement area) and performs some of change of the reduction direction of the reduction area, change of the enlargement area, and configuration of the clipping area as necessary (S1603: a correction processing step). The image correction unit 144 reduces the reduction area, enlarges the enlargement area, and clips the clipping area as necessary to generate an output image (S205: a correction processing step). The controller 40 outputs the generated output image to the printing unit 50 or the display unit 30.

Now, the details of the correction processing by the controller 140 will be described with processing examples.

### Processing Example 11

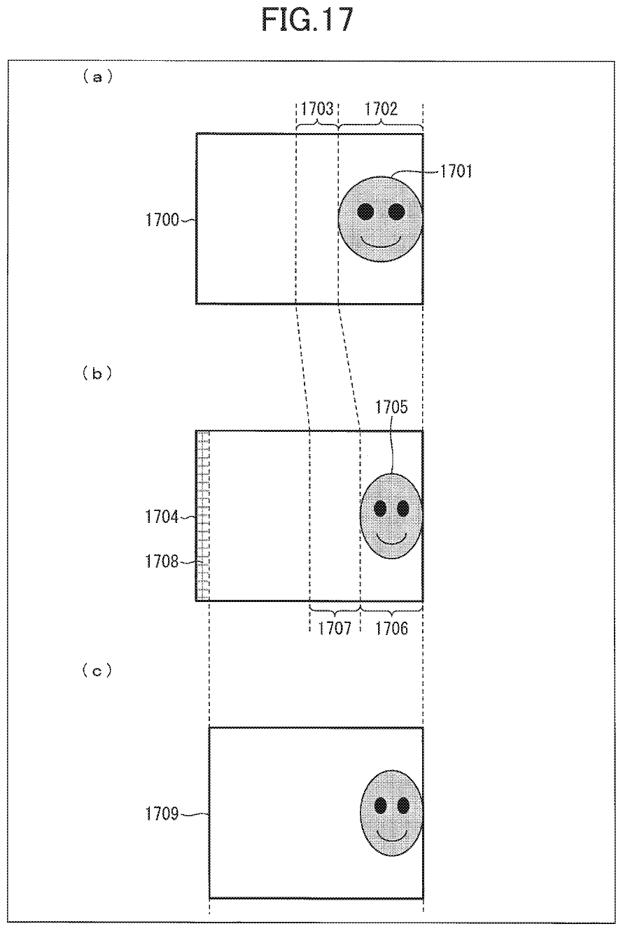

(a) of FIG. 17 illustrates an input image 1700 used in Processing Example 11 and a correction area (a reduction area 1702 and an enlargement area 1703) configured in the input image 1700 by the correction area configuration unit 142. In the input image 1700, a face (target area) 1701 of a person is located at the right end, and thus the correction area configuration unit 142 configures the reduction area 1702 such that the reduction area 1702 contacts the right side of the input image 1700. Thus, the correction area configuration unit 142 can configure the enlargement area 1703 only on the left side of the reduction area 1702, and fails to configure an enlargement area with a sufficient width on the right side of the reduction area 1702.

In this case, the correction direction configuration unit 143 changes the reduction direction of the reduction area 1702 so as to prevent the direction from extending from the right side of the input image 1700 toward the inside of the reduction area 1702. For example, the correction direction configuration unit 143 changes the reduction direction of the reduction area 1702 such that the direction extends toward the side (the right side of the input image 1700) located in proximity to the reduction area 1702. The correction direction configuration unit 143 reconfigures the enlargement area so as to avoid configuring the enlargement area on the side (right side of the input image 1700) located in proximity to the reduction area 1702 with respect to the reduction area 1702.

(b) of FIG. 17 illustrates an output image 1704 resulting from correction of the input image 1700 in which the width of the face 1705 is reduced in the reduction direction changed by the correction direction configuration unit 143. The width of the corrected face 1705 of the person (=the width of the corrected reduction area 1706) is smaller than the width of the uncorrected face 1701 of the person (=the width of the uncorrected reduction area 1702) by the correction.

Here, the reduction direction of the reduction area 1702 is rightward, and thus a correction is performed to transfer a point P=(e−1, y), where 1 is a distance from the right end x=e of the reduction area 1702, to a point P′=(e−α1, y), and the right end of the corrected reduction area 1706 is also x=e. This eliminates a need to configure the enlargement area on the right side of the reduction area 1702. Thus, as in Reference Example 1, even in a case that the reduction area is located closer to a certain side (first side) of the input image to prevent a sufficient enlargement area from being configured on the first side of the reduction area, formation, on the first side of the reduction area, of an area having indefinite pixel values can be avoided.

Note that, assume that the left end of the uncorrected reduction area 1702 is x=e−w, the left end of the corrected reduction area 1706 is x=e−αw, which is shifted rightward from x=e−w and that the image correction unit 144 thus shifts the enlargement area 1707 and an area on the left side of the enlargement area 1707 rightward. As a result, a shaded area 1704 located at the left end of an output image 1704 resulting from correction has indefinite pixel values.

Thus, the correction direction configuration unit 143 configures the area 1704 as a clipping area. As a result, as illustrated in (c) of FIG. 17, the image correction unit 144 can generate an output image 1709 resulting from clipping, from the output image 1704, of an area 1708 having indefinite pixel values. Thus, a preferable output image can be obtained that includes no area having indefinite pixel values.

Note that instead of configuring the area 1704 as a clipping area, the correction direction configuration unit 143 can enlarge an area between the area 1704 and the enlargement area 1707 so as to supplement the area 1704, thus obtaining a preferable output image including no area having indefinite pixel values.

As described above, in a case that the reduction direction of the reduction area extends from one side (first side) of the input image toward the inside of the reduction area, the correction direction configuration unit 143 in the present embodiment determines whether to change the reduction direction of the reduction area depending on the distance from the reduction area to the first side. In a case of changing the reduction direction of the reduction area, the correction direction configuration unit 143 changes the reduction direction of the reduction area so as to prevent the reduction direction from extending from the first side toward the inside of the reduction area. Thus, a preferable output image can be obtained that includes no area having indefinite pixel values.

### Processing Example 12

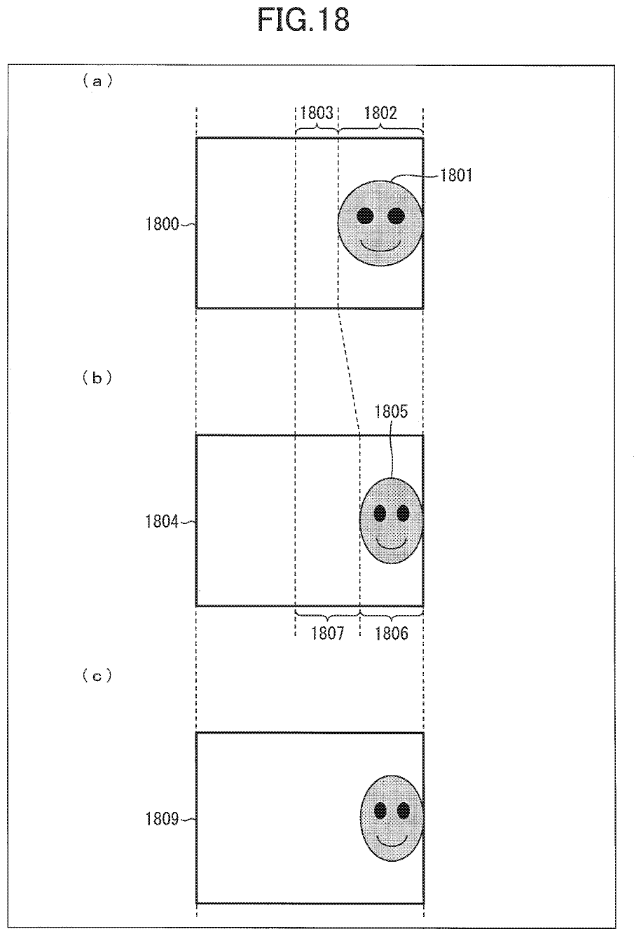

(a) of FIG. 18 illustrates an input image 1800 used in Processing Example 12 and a correction area (a reduction area 1802 and an enlargement area 1803) configured in the input image 1800 by the correction area configuration unit 142. In the input image 1800, a face (target area) 1801 of a person is located at the right end, and thus the correction area configuration unit 142 configures the reduction area 1802 such that the reduction area 1802 contacts the right side of the input image 1800. Thus, the correction area configuration unit 142 can configure the enlargement area 1803 only on the left side of the reduction area 1802, and fails to configure an enlargement area with a sufficient width on the right side of the reduction area 1802.

In this case, as is the case with Processing Example 11, the correction direction configuration unit 143 changes the reduction direction of the reduction area 1802 so as to prevent the reduction direction from extending from the right side of the input image 1800 toward the inside of the reduction area 1802, and reconfigures the enlargement area so as to avoid configuring the enlargement area on the side (right side of the input image 1800) located in proximity to the reduction area 1802 with respect to the reduction area 1802. Furthermore, the correction direction configuration unit 143 increases the enlargement ratio for the enlargement area 1803.

(b) of FIG. 18 illustrates an output image 1804 resulting from correction of the input image 1800 in which the width of a face 1805 is reduced in the reduction direction changed by the correction direction configuration unit 143. The width of the corrected face 1805 of the person (=the width of a corrected reduction area 1806) is smaller than the width of the uncorrected face 1801 of the person (=the width of the uncorrected reduction area 1802) by the correction. The reduced width of the reduction area 1802 is supplemented by thickening of the enlargement area 1803, and the area on the left side of a corrected enlargement area 1807 has not been enlarged or reduced. Thus, a preferable output image can be obtained that includes no area having indefinite pixel values.

### Implementation Example Based on Software

Control blocks of the controller (image processing apparatus) 40 and 140 (in particular, the imaging object detection unit 41, the correction area configuration unit 42, the correction intensity configuration unit 43, the clipping configuration unit 44, the image correction unit 45, the imaging object detection unit 141, the correction area configuration unit 142, the correction direction configuration unit 143, and the image correction unit 144) may be implemented by a logic circuit (hardware) formed in, for example, an integrated circuit (IC chip) such as an Application Specific Integrated Circuit (ASIC), or a Field Programmable Gate Array (FPGA), or may be implemented by software by using a Central Processing Unit (CPU) or a Graphics Processing Unit (GPU).

In the case of software implementation, the controllers (image processing apparatuses) 40 and 140 include a CPU performing instructions of a program that is software implementing the functions, a Read Only Memory (ROM) or a storage apparatus (these are referred to as “recording media”) in which the program and various data are stored so as to be readable by a computer (or CPU), a Random Access Memory (RAM) in which the program is decompressed, and the like. The computer (or CPU) reads from the recording medium and performs the program to achieve the object of the present invention. As the above-described recording medium, a “non-transitory tangible medium” such as a tape, a disk, a card, a semiconductor memory, and a programmable logic circuit can be used. The above-described program may be supplied to the above-described computer via an arbitrary transmission medium (such as a communication network and a broadcast wave) capable of transmitting the program. Note that one aspect of the present invention may also be implemented in a form of a data signal embedded in a carrier wave in which the program is embodied by electronic transmission.

### CONCLUSIONS

An image processing apparatus (controller 40) according to Aspect 1 of the present invention includes a correction processing unit configured to reduce a first area (reduction area) in an image and to enlarge a second area (enlargement area) outside the first area to correct the image (correction area configuration unit 42, correction intensity configuration unit 43, clipping configuration unit 44, and image correction unit 45), and in a case that a reduction direction of the first area extends from a first side of the image toward an inside of the first area, the correction processing unit determines whether to clip the first side of the image depending on a distance from the first area to the first side.

In the configuration described above, in a case that the reduction direction of the first area (reduction area) extends from the first side of the image toward the inside of the first area, and the distance from the first area to the first side is short, preventing a second area (enlargement area) with a sufficient width from being provided on the first side of the first area, an area having indefinite pixel values may be formed on the first side of the output image. Thus, by clipping the first side of the image depending on the distance from the first area to the first side, a preferable output image can be obtained that includes no area having indefinite pixel values.

The image processing apparatus according to Aspect 2 of the present invention includes Aspect 1 described above, wherein the correction processing unit may be configured to clip the first side of the image in a case that the first area and the first side adjoin.

According to the above-described configuration, even in a case that the first area (reduction area) contacts the first side of the input image and the second area (enlargement area) fails to be configured on the first side of the first area (reduction area), a preferable output image can be obtained that includes no area having indefinite pixel values.

The image processing apparatus according to Aspect 3 of the present invention includes Aspect 1 or 2 described above, wherein the correction processing unit may be configured to clip the first side of the image in a case that a distance from the first area to the first side is shorter than a width of the second area opposite to the first side across the first area.

According to the above-described configuration, even in a case that the first area (reduction area) is located close to the first side of the input image to prevent the second area (enlargement area) with a sufficient width from being configured on the first side of the first area (reduction area), a preferable output image can be obtained that includes no area having indefinite pixel values.

The image processing apparatus according to Aspect 4 of the present invention includes Aspects 1 to 3 described above, wherein the correction processing unit may be configured to clip a second side of the image that does not oppose the first side such that an aspect ratio of the image after correction is the same as an aspect ratio of the image before the correction.

According to the above-described configuration, an output image with the aspect ratio of the image maintained can be obtained.

The image processing apparatus according to Aspect 5 of the present invention includes Aspect 4, wherein the correction processing unit may be configured to clip as many as a first width of the second side and to specify, as the second side, one of sides of the image that do not oppose the first side of the image, with no pixel of interest included within the first width from the one side.

According to the above-described configuration, losing important portions of the output image can be avoided.

The image processing apparatus according to Aspect 6 of the present invention includes Aspect 4 described above, wherein the correction processing unit may be configured to specify, as the second side, one of sides of the image that do not oppose the first side, the one side being located farther from the first area.

According to the above-described configuration, in the output image, an object to serve as an object of interest can be located closer to the center of the image.

The image processing apparatus according to Aspect 7 of the present invention includes any one of Aspects 4 to 6 described above, wherein the correction processing unit may be configured to enlarge the image as a whole resulting from clipping of the first side and the second side such that the number of vertical pixels and the number of horizontal pixels in the image after correction are identical to the number of vertical pixels and the number of horizontal pixels in the image before the correction.

According to the above-described configuration, an output image can be obtained that maintains the numbers of vertical and horizontal pixels in the image.

The image processing apparatus according to Aspect 8 of the present invention includes Aspects 1 to 3 described above, wherein the correction processing unit may be configured to enlarge a third area located on a third side opposite to the first side with respect to the first area such that an aspect ratio of the image after correction is identical to an aspect ratio of the image before the correction.

According to the above-described configuration, an output image with the aspect ratio of the image maintained can be obtained.

The image processing apparatus according to Aspect 9 of the present invention includes Aspect 8 described above, wherein the correction processing unit may be configured to specify, as the third area, a part of an area located on the third side with respect to the first area, the part including no pixel of interest.

According to the above-described configuration, a high-quality output image can be obtained that maintains the aspect ratio with important portions prevented from being deformed.

An image processing apparatus (controller 140) according to Aspect 10 of the present invention includes a correction processing unit configured to reduce a first area (reduction area) in an image and to enlarge a second area (enlargement area) outside the first area to correct the image (correction area configuration unit 142, correction direction configuration unit 143, and image correction unit 144). In a case that a reduction direction of the first area extends from a first side of the image toward an inside of the first area, the correction processing unit determines whether to change the reduction direction of the first area to prevent the reduction direction from extending from the first side of the image toward the inside of the first area depending on a distance from the first area to the first side.

In the configuration described above, in a case that the reduction direction of the first area (reduction area) extends from the first side of the image toward the inside of the first area, and the distance from the first area to the first side is short, preventing a second area (enlargement area) with a sufficient width from being provided on the first side of the first area, an area having indefinite pixel values may be formed on the first side of the output image. Thus, depending on the distance from the first area to the first side, a preferable output image including no area having indefinite pixel values can be obtained by changing the reduction direction of the first area to prevent the reduction direction from extending from the first side of the image toward the inside of the first area.

An imaging apparatus 2 according to an Aspect 11 of the present invention includes an imaging unit 10, and the image processing apparatus according to any one of Aspects 1 to 10 described above, the image processing apparatus being configured to correct the image captured by the imaging unit 10.

According to the above-described configuration, a user can capture an image of a face of a person and preferably perform image processing on the captured image.

An image printing apparatus according to Aspect 12 of the present invention includes the image processing apparatus according to any one of Aspects 1 to 10 described above, and a printing unit 50 configured to print the image corrected by the image processing apparatus.

According to the above-described configuration, the user can easily print an image obtained by performing the image processing.

An image printing apparatus 1 according to Aspect 13 of the present invention includes an imaging unit 10, the image processing apparatus according to any one of Aspects 1 to 10 described above, the image processing apparatus being configured to perform image processing on the image captured by the imaging unit 10, and a printing unit 50 configured to print the image corrected by the image processing apparatus.

According to the above-described configuration, the user can easily print an image obtained by performing image processing on the captured image.

A control method for an image processing apparatus according to Aspect 14 of the present invention includes the step of correcting an image by reducing a first area in the image and enlarging a second area outside the first area, and the step of correcting the image includes determining, in a case that a reduction direction of the first area extends from the first side toward an inside of the first area, whether to clip the first side of the image depending on a distance from the first area to the first side.

A control method for an image processing apparatus according to Aspect 15 of the present invention includes the step of correcting an image by reducing a first area in the image and enlarging a second area outside the first area, wherein the step of correcting the image includes determining, in a case that a reduction direction of the first area extends from the first side toward an inside of the first area, whether to change the reduction direction of the first area to prevent the reduction direction from extending from the first side of the image toward the inside of the first area depending on a distance from the first area to the first side.

According to the above-described configurations, effects similar to the effects of the image processing apparatus according to an aspect of the present invention are exerted.

The image processing apparatus according to each of the aspects of the present invention may be implemented by a computer. In this case, the present invention embraces also an image processing program that implements the above-described image processing apparatus by a computer by causing the computer to operate as each of the units (software elements) included in the above-described image processing apparatus, and a computer-readable recording medium in which the program is recorded.

### Supplemental Note

The present invention is not limited to each of the above-described embodiments. It is possible to make various modifications within the scope of the claims. An embodiment obtained by appropriately combining technical elements each disclosed in different embodiments falls also within the technical scope of the present invention. Further, a combination of technical elements disclosed in the respective embodiments allows formation of a new technical feature.

### CROSS-REFERENCE OF RELATED APPLICATION

This application claims the benefit of priority to JP 2017-084003 filed on Apr. 20, 2017, which is incorporated herein by reference in its entirety.

### REFERENCE SIGNS LIST

1 Image printing apparatus
2 Imaging apparatus
10 Imaging unit
40, 140 Controller (image processing apparatus)
41, 141 Imaging object detection unit (target area detection unit)
42, 142 Correction area configuration unit (correction processing unit)
43 Correction intensity configuration unit (correction processing unit)
44 Clipping configuration unit (correction processing unit)
45, 144 Image correction unit (correction processing unit)
143 Correction direction configuration unit (correction processing unit)
50 Printing unit

1. An image processing apparatus comprising:
a correction processing unit configured to reduce a first area in an image and to enlarge a second area outside the first area to correct the image, wherein
in a case that a reduction direction of the first area extends from a first side of the image toward an inside of the first area, the correction processing unit determines whether to clip the first side of the image depending on a distance from the first area to the first side.

2. The image processing apparatus according to claim 1, wherein
the correction processing unit clips the first side of the image in a case that the first area and the first side adjoin.

3. The image processing apparatus according to claim 1, wherein
the correction processing unit clips the first side of the image in a case that a distance from the first area to the first side is shorter than a width of the second area opposite to the first side across the first area.

4. The image processing apparatus according to claim 1, wherein
the correction processing unit clips a second side of the image that does not oppose the first side such that an aspect ratio of the image after correction is the same as an aspect ratio of the image before the correction.

5. The image processing apparatus according to claim 4, wherein
the correction processing unit clips as many as a first width of the second side and specifies, as the second side, one of sides of the image that do not oppose the first side of the image, with no pixel of interest included within the first width from the one side.

6. The image processing apparatus according to claim 4, wherein
the correction processing unit specifies, as the second side, one of sides of the image that do not oppose the first side, the one side being located farther from the first area.

7. The image processing apparatus according to claim 4, wherein
the correction processing unit enlarges the image as a whole resulting from clipping of the first side and the second side such that the number of vertical pixels and the number of horizontal pixels in the image after correction are identical to the number of vertical pixels and the number of horizontal pixels in the image before the correction.

8. The image processing apparatus according to claim 1, wherein
the correction processing unit enlarges a third area located on a third side opposite to the first side with respect to the first area such that an aspect ratio of the image after correction is identical to an aspect ratio of the image before the correction.

9. The image processing apparatus according to claim 8, wherein
the correction processing unit specifies, as the third area, a part of an area located on the third side with respect to the first area, the part including no pixel of interest.

10. The image processing apparatus according to claim 1,
wherein
in a case that a reduction direction of the first area extends from a first side of the image toward an inside of the first area, the correction processing unit determines whether to change the reduction direction of the first area to prevent the reduction direction from extending from the first side of the image toward the inside of the first area depending on a distance from the first area to the first side.

11-13. (canceled)

14. A control method for an image processing apparatus, the control method comprising the step of:
correcting an image by reducing a first area in the image and enlarging a second area outside the first area, wherein
the step of correcting the image includes determining, in a case that a reduction direction of the first area extends from the first side toward an inside of the first area, whether to clip the first side of the image depending on a distance from the first area to the first side.

15. (canceled)

16. A non-transitory recording medium containing an image processing program causing a computer to operate as a correction processing unit configured to reduce a first area in an image and to enlarge a second area outside the first area to correct the image, wherein in a case that a reduction direction of the first area extends from a first side of the image toward an inside of the first area, the correction processing unit determines whether to clip the first side of the image depending on a distance from the first area to the first side.
